(19) United States
(12) Patent Application Publication
(10) Pub. No.: US 2025/0289071 A1
(43) Pub. Date: Sep. 18, 2025

(54) CUTTING DEVICE

(71) Applicant: FURUKAWA ELECTRIC CO., LTD., Tokyo (JP)

(72) Inventors: Akihiro Komatsuzaki, Tokyo (JP); Tomohiro Akiyama, Tokyo (JP)

(21) Appl. No.: 19/220,920

(22) Filed: May 28, 2025

Related U.S. Application Data
(63) Continuation of application No. PCT/JP2023/045958, filed on Dec. 21, 2023.

(30) Foreign Application Priority Data
Dec. 27, 2022 (JP) 2022-209902

(51) Int. Cl. B23D 47/08

(52) U.S. Cl. CPC B23D 47/08

(57) ABSTRACT

A blade member is disposed above a cutting unit. The blade member is a substantially disc-shaped member, and the circumferential part serves as a blade tip. The blade member is stored in positioning members. When the positioning members are caused to counterpose and are then joined to each other, a slit is formed at the upper portion of the positioning members. A pair of projections projecting to the inner surface side are formed at one of the counterposing edges of the slit. The projections are formed at two positions with the center axis of the blade member therebetween. One surface of the blade member comes into surface-contact with the inner surface of the positioning member, and the blade member is pressed in the direction of the slit by an elastic member, whereby a tapered part on the other surface of the blade member comes into point-contact with the projections and is positioned therein.

### TECHNICAL FIELD

The present invention relates to a cutting device for cutting an optical fiber.

### BACKGROUND OF THE INVENTION

When an optical fiber is to be fusion spliced, conventionally, coating of an optical fiber core is removed first and then the optical fiber is cut into predetermined size. As a cutting device for cutting the optical fiber, there has been a device that removes the coating of the optical fiber core to expose a glass fiber portion and scratches a surface of the glass fiber portion by contacting a disc-shaped blade member to cut the optical fiber.

However, in such a device for cutting an optical fiber, depth of the scratch made to the optical fiber core is to be controlled with high precision. For example, if positional relationship between the optical fiber core and the blade member is inaccurate, the scratch may be imperfect or the blade member may hit the optical fiber core excessively, damaging the optical fiber core, and these may cause defects. For this reason, the blade member is to be positioned to the optical fiber core with precision of 10 μm or less, for example.

In general, a blade member used in a cutting device is in a disc shape. By rotating a disc-shaped blade member, a blade tip that has been worn out due to abrasion or the like can be replaced with a fresh portion.

Such the circular blade member is usually fixed at a center thereof. Thus, a gap between a hole and a shaft at the center may cause an error in height of the blade member at the time of attachment, and this may change height of the blade. The height of the blade tip may also change when the blade member itself is not perfectly circular or the position of the center hole is misaligned. Thus, it has been difficult to set the height of the blade tip with high precision.

In contrast, Japanese Unexamined Patent Application Publication No. 2018-163195 (JP-A-2018-163195) has proposed a method in which a blade member is positioned not at the center but at a part close to the blade tip.

According to JP-A-2018-163195, a positioning mechanism by surface-contact or point-contact is provided at a tapered portion of the blade member so that the height of the blade tip can be set without being affected by position misalignment or eccentricity etc. of the center hole of the blade member.

However, when the positioning member is brought into surface-contact with the tapered portion of the blade member as in JP-A-2018-163195, depending on accuracy of the positioning member and fixing accuracy, there may be cases where the positioning member does not come into complete surface-contact, but is misaligned and comes into contact at an angle, and this may change the height of the blade tip.

Also, even if the positioning member is to perform positioning in a height direction by point-contact, there may be cases where heights of positioning portions on both sides may not match. Also, because of the point-contact, the axis of the blade member may be misaligned and the blade member may not be butted perpendicularly against the optical fiber. Furthermore, with positioning by point-contact, it is difficult to perform accurate positioning in a direction perpendicular to the height direction (a direction in which the blade member moves) and a position of the blade member may be misaligned.

When the position of the blade member changes as above, the depth of the scratch made to the optical fiber may change as well. This makes it difficult to cut the optical fiber with high precision, and may deteriorate cutting quality of the optical fiber.

### SUMMARY OF THE INVENTION

The present invention was made in view of such problems. It is an object of the present invention to provide a cutting device in which a blade member can be positioned with higher precision and an optical fiber can be cut under fixed conditions.

To achieve the above object, an aspect of the present invention is a cutting device for cutting an optical fiber including a base, a disc-shaped blade member, a positioning member that is provided on the base and restricts a position of the blade member, a support part that is disposed so as to be variable in height with respect to the base and supports the blade member, and a first elastic member that presses the support part to a positioning portion of the positioning member with respect to the base. The positioning member includes a slit and a projection is formed on one of facing edges of the slit so as to project toward an inner surface side. The projection is formed at two places with an axis of the blade member therebetween when viewed from above. The blade member is stored inside the positioning member, and one surface of the blade member is in surface-contact with an inner surface of the positioning member. The first elastic member presses the blade member toward the slit so that a tapered portion on the other surface of the blade member is positioned by being in point-contact with each projection and tip of the blade member protrudes to a surface side of the slit.

It is preferable that a pair of the projections are disposed at positions that are symmetrical with respect to a vertical centerline passing through the axis of the blade member.

It is preferable that, when viewed from an axial direction of the blade member, a tip of the projection is formed in an arc shape and an arc-shaped portion of the projection is in point-contact with the tapered portion of the blade member.

It is preferable that the cutting device further includes a second elastic member that presses the blade member in a direction of the support part, which is the axial direction of the blade member, and the second elastic member presses the one surface of the blade member to the inner surface of the positioning member.

According to the present invention, the elastic member allows the one surface of the blade member to come into surface-contact with the inner surface of the positioning member, thereby restricting orientation of the axis of the blade member with certainty. That is, orientation of a blade portion of the blade member with respect to the optical fiber can be kept constant. Also, the tapered portion on the other surface of the blade member comes into point-contact with each of the pair of projections of the positioning member so that the blade member can be positioned with high precision.

Also, the projections are disposed at the positions that are symmetrical to the centerline passing through the axis of the blade member, and this allows the blade member to be positioned with high precision.

Also, the second elastic member presses the blade member to the inner surface of the positioning member so that the blade member can be brought into surface-contact with the inner surface of the positioning member with certainty.

The present invention can provide a cutting device in which a blade member can be positioned with higher precision and an optical fiber can be cut under fixed conditions.

### BRIEF DESCRIPTION OF DRAWINGS

FIG. 1 is a perspective view showing a cutting device 1.

FIG. 2A is an upper perspective view of a cutting unit 9.

FIG. 2B is a lower perspective view of the cutting unit 9.

FIG. 3A is a perspective view of a back side of the cutting unit 9.

FIG. 3B is a plan view of the cutting unit 9.

FIG. 4 is a schematic view showing a positioning mechanism of a blade member 19.

FIG. 5A is an exploded perspective view of the blade member 19 and positioning members 15a and 15b.

FIG. 5B is an enlarged view of a section E in FIG. 5A.

FIG. 6A is a perspective view of the positioning member 15b when the blade member 19 and the positioning members 15a and 15b are assembled.

FIG. 6B is an enlarged view of a section F in FIG. 6A.

FIG. 7A is a perspective view showing a positional relationship between the blade member 19 and projections 35.

FIG. 7B is a plan view showing the positional relationship between the blade member 19 and the projections 35.

### DESCRIPTION

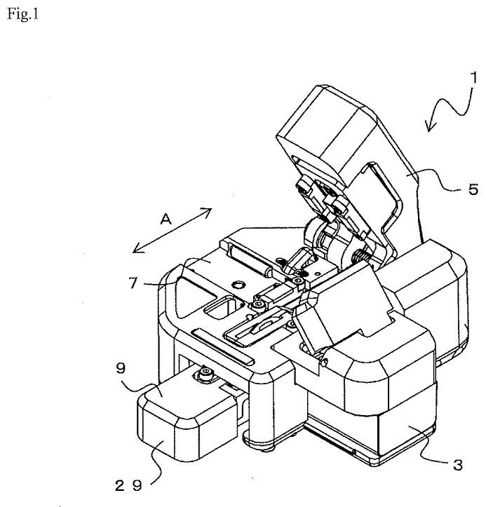

Hereinafter, embodiments of the present invention will be described with reference to the accompanying drawings. FIG. 1 is a perspective view showing a cutting device 1. The cutting device 1 mainly includes a main body 3, a lid portion 5, a cutting unit 9, and so on. The cutting device 1 is a device for cutting an optical fiber at a predetermined position.

A holder-mounting portion 7 is formed on an upper surface of the main body 3. A holder holding the optical fiber is to be mounted on the holder-mounting portion 7. A glass fiber portion that has been exposed by removing a coating of the optical fiber protrudes from an end of the holder. When the holder is disposed on the holder-mounting portion 7, the optical fiber is disposed striding over a moving range of the cutting unit 9.

In a normal state, a handling portion 29 of the cutting unit 9 protrudes from the main body 3. When the handling portion 29 is pushed into the main body 3 from such the state, the cutting unit 9 moves inside the main body 3. At this time, since the cutting unit 9 is pressed in a direction to be pushed out from the main body 3 by an elastic member, the cutting unit 9 is pushed inside the main body 3 against pressing force of the elastic member. When the cutting unit 9 is pushed in completely, a blade tip of the cutting unit 9 moves to a rear side beyond the optical fiber. In such the state, the cutting unit 9 is held by a locking portion, of which illustration is omitted.

If the lid portion 5 is closed in such the state, the locking portion that has held the cutting unit 9 is released and the above-mentioned elastic member pushes the cutting unit 9 out from the main body 3. That is, the cutting unit 9 moves. That is, the cutting unit 9 is movable in both ways of a direction A in the drawing. When the cutting unit 9 moves, the blade tip comes into contact with the optical fiber, scratching the optical fiber, and the optical fiber can be cut by applying bending stress or the like to the scratched part.

As above, the cutting unit 9 (the handling portion 29) is normally kept protruding from the main body 3 and is pushed into the main body 3 when in use. In this way, the cutting unit 9 can be easily pushed in when the main body 3 is placed on a desk or the like to be operated, for example.

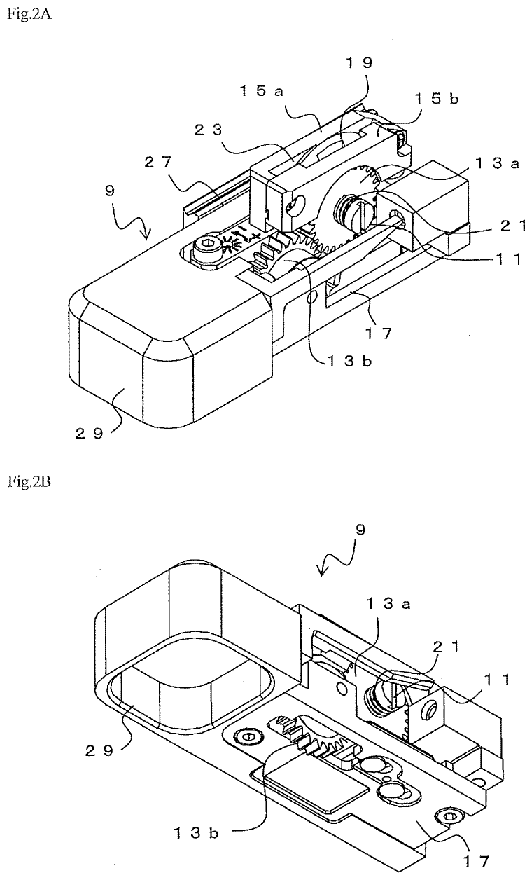

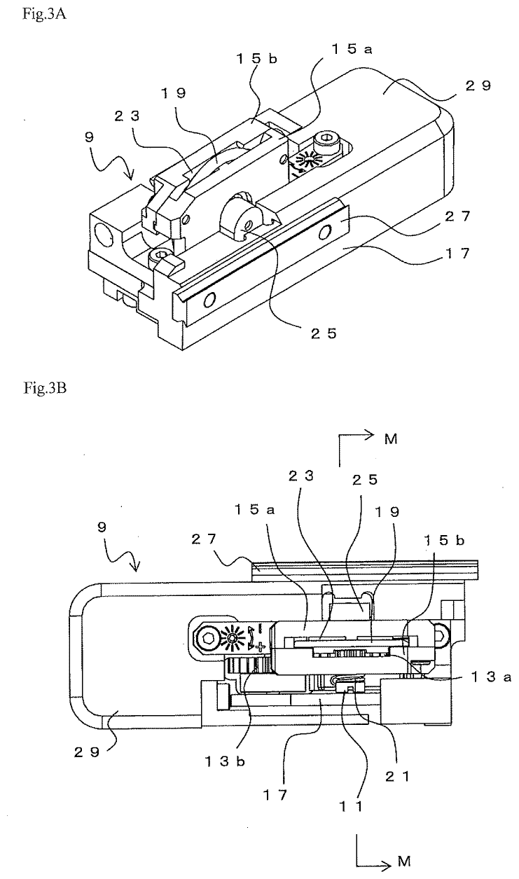

Next, the cutting unit 9 will be described. FIG. 2A is an upper perspective view of the cutting unit 9, FIG. 2B is a lower perspective view of the cutting unit 9, FIG. 3A is a perspective view of a back side of the cutting unit 9, and FIG. 3B is a plan view of the cutting unit 9. The cutting unit 9 includes a base 17, a support part 25 (FIG. 3A and FIG. 3B), a blade member 19, positioning members 15a and 15b, and so on.

A rail 27 is fixed on a side surface of the base 17. The rail 27 can slidably move with respect to a slide block (not shown) that is fixed to the main body 3 of the cutting device 1. That is, the cutting unit 9 is movable in the direction A in FIG. 1 with respect to the main body 3.

The blade member 19 is disposed on an upper part of the cutting unit 9. The blade member 19 is a substantially disc-shaped member and a circumferential part thereof serves as a blade tip. The blade member 19 is stored inside the positioning members 15a and 15b. The positioning members 15a and 15b are members for restricting a position of the blade member 19 and are fixed to the base 17. When the positioning members 15a and 15b are brought to face each other and then joined to each other, a slit 23 is formed at an upper part of the positioning members 15a and 15b. A tip of the blade member 19 protrudes from the slit 23 toward a front surface side (upward) of the positioning members 15a and 15b.

A part of an inner edge of the slit 23 comes into contact with the blade member 19. Thus, the positioning members 15a and 15b serve as a positioning portion for restricting the position of the blade member 19. A method for positioning the blade member 19 in the positioning members 15a and 15b will be described in detail below.

A concave portion is formed on a bottom side of the handling portion 29. In this way, a user can insert fingers into the concave portion of the handling portion 29 to handle the cutting unit 9.

For example, as mentioned above, the handling portion 29 is normally kept protruding from the main body 3 so that operability is good when the main body 3 is placed on a desk to be operated. On the other hand, when the main body 3 is held in hands to be operated, an end of the handling portion 29 is away from the main body 3, which makes operation difficult for users with small hands. However, providing the concave portion, into which fingers can be inserted, on a back surface of the handling portion 29 makes operability excellent even if the main body 3 is held in hands during the operation.

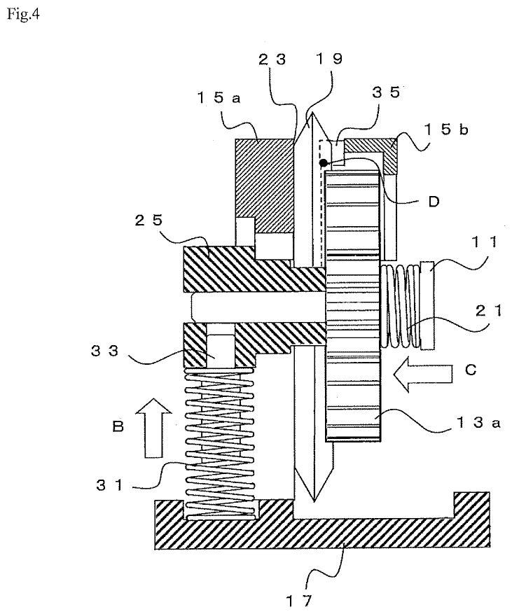

A part of a gear 13b protrudes from a bottom surface side of the cutting unit 9. The gear 13b is an operation unit for rotating the blade member 19. FIG. 4 is a cross-sectional perspective view taken along M-M line in FIG. 3B. A gear 13a is fixed to the blade member 19. The gear 13b meshes with the gear 13a that is fixed to the blade member 19. Thus, rotating the gear 13b allows the blade member 19 to rotate along with the gear 13a.

In this way, the gear 13b can change the circumferential position of the blade member 19 protruding from the slit 23. Thus, the circumferential position at which the blade member 19 contacts the optical fiber can be changed. The method for rotating the blade member 19 is not specifically limited thereto. Also, when in use, a stopper (not shown) restricts the rotation of the gear 13b so that the blade member 19 is fixed at a predetermined circumferential position.

The support part 25 is fixed on one side of the blade member 19. A pin 33 is connected at a lower part of the support part 25. Also, an elastic member 31, which is a first elastic member, is disposed on an outer periphery of the pin 33. The support part 25 is disposed so as to be variable in height with respect to the base 17 and supports the blade member 19. The elastic member 31 presses the support part 25 upward with respect to the base 17. Since the positioning members 15a and 15b are fixed to the base 17, the blade member 19 fixed to the support part 25 is pressed toward upper part of the positioning members 15a and 15b (in a direction of the slit 23, i.e. in a direction of the positioning portions) (an arrow B in the drawing).

To adjust a tip position of the blade member 19, heights of the positioning members 15a and 15b with respect to the base 17 may be adjusted. For example, the heights of the positioning members 15a and 15b with respect to the base 17 may be fine-tuned by pushing down the positioning member 15a with a screw provided in a long hole of the positioning member 15a and pushing up the positioning member 15a with a set screw provided in a separately provided screw hole. Thus, the tip position of the blade member 19 with respect to the base 17 can be fine-tuned. The height adjustment for the positioning members 15a and 15b with respect to the base 17 is not always required and, also, another method may be used to adjust the heights of the positioning members 15a and 15b.

At this time, a projection 35 is formed on an inner surface side of the positioning member 15b as a positioning portion for the blade member 19. The blade member 19 is positioned by contacting the projection 35. The positioning of the positioning member 15b by the projection 35 will be described in detail below.

Also, the blade member 19 is disposed so as to be placed between the gear 13a and the support part 25 and is fixed with a fixing screw 11. Also, a part of the positioning member 15a is placed in a gap between the support part 25 and the blade member 19. At this time, an elastic member 21, which is a second elastic member, is disposed in a gap between a head of the fixing screw 11 and the gear 13a.

The elastic member 21 presses the blade member 19 toward the support part 25, in an axial direction of the blade member 19 (the left-right direction in the drawing), and thus the elastic member 21 presses one surface of the blade member 19 (a surface on the left side in the drawing, which is substantially perpendicular to the axial direction except for a tapered portion) against the inner surface of the positioning member 15a (an arrow C in the drawing). Thus, the one surface of the blade member 19 can come into surface-contact with the inner surface of the positioning member 15a that is fixed to the base 17.

By bringing the one surface of the blade member 19 into surface-contact with the inner surface of the positioning member 15a, the position of the blade member 19 in the axial direction (the position in the left-right direction in the drawing) can be positioned with certainty. In addition, since the blade member 19 and the positioning member 15a are pressed against each other through surface-contact, axial misalignment of the blade member 19 (a planar part of the blade member 19 being oriented diagonally with respect to the moving direction (a direction perpendicular to the paper surface) or a height direction of the blade member 19) can be suppressed, and thus the axial direction of the blade member 19 can be maintained perpendicular to either the moving direction and the height direction of the blade member 19.

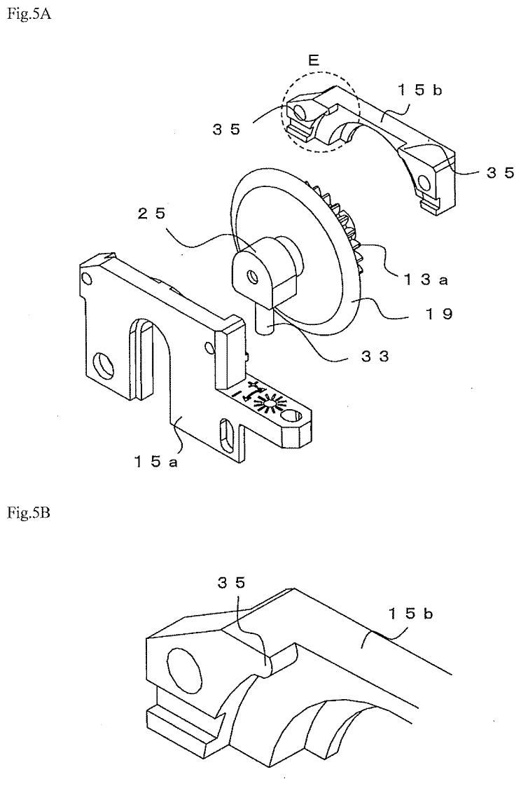

Next, the method for positioning the blade member 19 by the positioning member 15b will be described in detail. FIG. 5A is an exploded perspective view of the positioning members 15a and 15b and the blade member 19. As mentioned above, the inner surface of the positioning member 15a is in surface-contact with the one planar part of the blade member 19. Meanwhile, a pair of the projections 35 are formed at an upper part of the positioning member 15b on a side surface thereof that is opposite to the positioning member 15a.

FIG. 5B is an enlarged view of a section E in FIG. 5A. The projections 35 project toward the inner surface side at the upper part of the positioning member 15b. Thus, when the positioning members 15a and 15b are joined and fixed to each other, the projections 35 are positioned at proximities of both end portions of the slit 23.

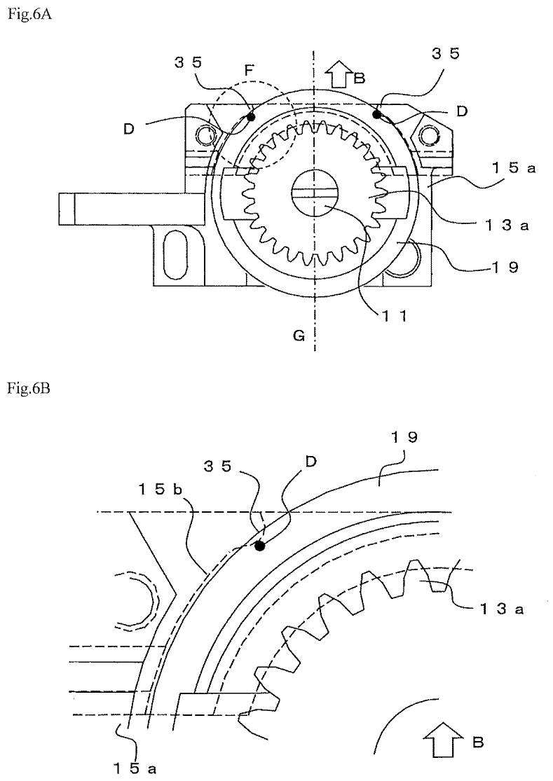

FIG. 6A is a view showing a state in which the blade member 19 is stored inside the positioning members 15a and 15b, and is a perspective view of the positioning member 15b (the positioning member 15b is shown by dotted lines). As shown in FIG. 6A, a pair of the projections 35 projecting to the inner surface side are formed, as the positioning portion for the blade member 19, on one of facing edges of the slit 23 (an edge portion of the inner surface of the positioning member 15b). The projections 35 are formed at two positions with a vertical centerline (axis) of the blade member 19 therebetween.

Also, as mentioned above, the blade member 19 is in a substantially disc shape, and a tapered portion, of which thickness gradually decreases toward the outer periphery, is formed on an outer edge side of the planar part at the center. Thus, when the blade member 19 is pressed upward (a direction of the arrow B in the drawing), the tapered portion of the blade member 19 comes into contact with the projections 35 (a section D in the drawing).

In more detail, a part of the blade member 19 is inserted from a back side of the slit 23, and, with respect to the tapered portions formed on both sides of the blade tip of the blade member 19, one of the tapered portions comes into contact with each of the projections 35 on the inner edge of the slit 23. At this time, the tip of the blade member 19 protrudes toward a surface side of the slit 23.

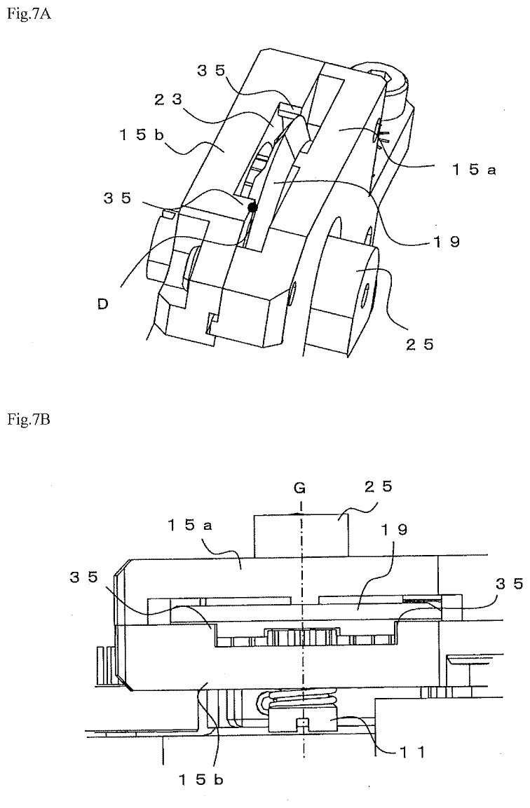

FIG. 6B is an enlarged view of a section F in FIG. 6A. Also, FIG. 7A is an upper perspective view showing a contacting portion between the projections 35 and the blade member 19, and FIG. 7B is an upper plan view of the blade member 19.

As shown in FIG. 6B, when viewed from the axial direction of the blade member 19, tips of the projections 35 (the contacting portions with the blade member 19) are formed arc-shaped. Also, since the tapered portion of the blade member 19 is formed in a circular shape along the outer periphery, the arc portions of the projections 35 are in point-contact with the tapered portion of the blade member 19. That is, the blade member 19 is pressed upward (toward the slit 23) by the elastic member 31, and the tapered portion of the blade member 19 comes into contact with the projections 35, thereby restricting the further upward movement. As a result, the blade member 19 can be positioned in the height direction.

At this time, as shown in FIG. 6A, the pair of projections 35 are disposed at positions symmetrical to a centerline extending in the height direction of the blade member 19 (a vertical centerline passing through the axis, i.e. G in the drawing). That is, the blade member 19 is positioned, with respect to the height direction, at two points when viewed from above. By performing the positioning at the two points of the positions that are predetermined distance away from the centerline (axis) in this way, the blade member 19 can be positioned also with respect to a moving direction (the left-right direction in the drawing).

As above, the one surface of the blade member 19 is in surface-contact with the inner surface of the positioning member 15a and, at the same time, the elastic member 31 presses the blade member 19 toward the slit 23 so that the tapered portion on the other surface of the blade member comes into point-contact with the projections 35 and the blade member 19 is positioned. In this way, even if a slight misalignment occurs when joining the positioning members 15a and 15b, the blade member 19 still can be positioned with high precision since only the positioning member 15b performs the positioning of the blade member 19 in the height and moving directions and the positioning member 15a suppresses misalignment (tilting) of the axis of the blade member 19.

As described above, according to the embodiments of the present invention, by providing the elastic member 31 that presses the blade member 19 to the positioning member 15b, which restricts the height of the blade member 19, the height of the tip of the blade member 19 protruding to the surface side of the slit 23 can be kept constant even if a rotational axis of the blade member 19 is eccentric. That is, the positional relationship between the optical fiber and a blade portion of the blade member 19 can be kept constant.

Also, the elastic member 21 allows the blade member 19 to come into surface-contact with the inner surface of the positioning member 15a. This can restrict the orientation of the axis of the blade member 19 with certainty. That is, the orientation of the blade portion of the blade member 19 with respect to the optical fiber can be kept constant.

In this way, the blade member 19 can scratch the optical fiber under fixed conditions at all times. As a result, it is possible to suppress occurrence of variation in cross-sectional shapes or poor cutting of the optical fiber caused by variation in the depth of the scratch. Thus, cutting quality of the optical fiber can be improved.

Also, precision in machining the rotational axis of the blade member 19 is not required to be so high, which facilitates manufacturing of the blade member 19 and cuts down machining cost of the blade member 19.

For example, as mentioned above, rotating the gear 13b can easily rotate the blade member 19. This can change the circumferential position of the blade member 19 that comes into contact with the optical fiber. At this time, if a length from a rotation center to the blade tip of the blade member 19 is perfectly constant in the circumferential direction, the position of the tip blade does not change even when the blade member 19 is rotated. On the other hand, if the rotational axis of the blade member 19 is slightly eccentric, the distance from the rotation direction to the blade tip of the blade member 19 changes when the blade member 19 is rotated.

In contrast, in the present invention, proximities of the tip end of the blade member 19 is positioned by coming into point-contact with each of the pair of projections 35 on the inner edge of the slit 23. Thus, even if the axis of the blade member 19 is eccentric, the length of the tip blade of the blade member 19 protruding from the slit 23 can be kept substantially constant.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

For example, as long as the blade member 19 can be pressed against the positioning members 15a and 15b in the predetermined direction, arrangements of the elastic members 21 and 31 and a structure of the support part 25 etc. are not limited to the illustrated examples.

Also, although the elastic member 21 disposed at the axis of the blade member 19 presses the blade member 19 against the inner surface of the positioning member 15a to be in surface-contact, alternatively, the blade member 19 may be fastened by another fixing member or the like, without using the elastic member 21, so as to bring the blade member 19 into surface contact with the inner surface of the positioning member 15a.

Also, although the pair of the projections 35 are disposed symmetrically to the centerline of the blade member 19, the positions of the projections 35 may not necessarily be symmetrical as long as positioning of the blade member 19 is possible.

1. A cutting device for cutting an optical fiber, the cutting device comprising:
a base;
a disc-shaped blade member;
a positioning member for restricting a position of the blade member, the positioning member being provided on the base;
a support part for supporting the blade member, the support part being disposed so as to be variable in height with respect to the base; and
a first elastic member that presses the support part to a positioning portion of the positioning member with respect to the base, wherein
the positioning member includes a slit;
a projection is formed as the positioning portion on one of facing edges of the slit so as to project toward an inner surface side;
the projection is formed at two places with an axis of the blade member therebetween when viewed from above;
the blade member is stored inside the positioning member;
one surface of the blade member is in surface-contact with an inner surface of the positioning member; and
the first elastic member presses the blade member toward the slit so that a tapered portion on the other surface of the blade member is positioned by being in point-contact with each projection and a tip of the blade member protrudes to a surface side of the slit.

2. The cutting device according to claim 1, wherein a pair of the projections are disposed at positions that are symmetrical with respect to a vertical centerline passing through the axis of the blade member.

3. The cutting device according to claim 1, wherein when viewed from an axial direction of the blade member, a tip of the projection is formed in an arc shape and an arc-shaped portion of the projection is in point-contact with the tapered portion of the blade member.

4. The cutting device according to claim 1 further comprising:
a second elastic member that presses the blade member in a direction of the support part, which is the axial direction of the blade member, wherein
the second elastic member presses the one surface of the blade member to the inner surface of the positioning member.
